(19) United States
(12) Patent Application Publication
(10) Pub. No.: US 2010/0276616 A1
(43) Pub. Date: Nov. 4, 2010

(54) FLOW CONTROL VALVE

(76) Inventor: Si-Hwan Kim, Inchon (KR)

Correspondence Address: Hershkovitz & Associates, LLC, 2845 Duke Street, Alexandria, VA, 22314, US

(21) Appl. No.: 12/742,090

(22) PCT Filed: Oct. 20, 2008
(86) PCT No.: PCT/KR2008/006206

§ 371 Date: Jul. 26, 2010

(30) Foreign Application Priority Data
Nov. 7, 2007 (KR) 10-2007-0113037

(51) Int. Cl. F16K 31/04; F16K 31/64

(52) U.S. Cl. 251/129.11

(57) ABSTRACT

The present invention relates to a flow control valve that is capable of rapidly supplying hot water at a user's desired temperature by promptly controlling the opening rate of a valve depending on the flow of supplied direct water. In order to implement this, the flow control valve according to the present invention includes a motor that rotates in both directions; an opening and closing member that reciprocates by rotation of the motor to control the opening rate of a channel; a position varying member of which a position varies integrally with the opening and closing member by the rotation of the motor; and a valve opening rate sensing unit that senses the opening rate of the valve from an output voltage varying depending on the position of the position varying member.

### TECHNICAL FIELD

The present invention relates to a flow control valve, and more particularly, to a flow control valve that is installed in a boiler or a water heater and can control the flow of direct water supplied to a heat exchanger.

### BACKGROUND ART

In general, a flow control valve that control the flow of water supplied through a direct water pipe is provided in a boiler or a water heater that supplies hot water.

FIG. 1 is a schematic view illustrating a hot water supply system with a known flow control valve. Referring to FIG. 1, the hot water supply system includes a direct water pipe 10 through which direct water flows in, a flow control valve 20 that controls the flow of the direct water supplied through the direct water pipe 10, a direct water temperature sensor 30 that senses the temperature of the direct water passing the flow control valve 20, a flow sensor 40 for measuring the flow of the direct water flowing through the direct water pipe 10, a heat exchanger 50 where heat is exchanged between a high-temperature heat source and the direct water, a flow-out water temperature sensor 60 for measuring the temperature of the hot water heated in the heat exchanger 50, a hot water pipe 70 through which the heated hot water is discharged, and a control unit 80 that control the opening of the flow control valve 20 from flow information measured by the flow sensor 40.

When a user opens a water faucet to use the hot water, the flow sensor 40 senses the flow and ignites a burner (not shown) to supply the heat to the heat exchanger 50. In this case, when the flow of the supplied direct water is large, hot water at a desired temperature may not be supplied even though the water heater is operated at the maximum capacity.

Accordingly, in this case, the flow of the direct water is decreased by controlling the flow control valve 20. Since the flow is controlled by continuous feedback processes among the flow sensor 40, the control unit 80, and the flow control valve 20 in order to decrease the flow to a desired level, it is not possible to rapidly supply the hot water at the desired temperature to the user due to a low response speed.

### DISCLOSURE OF INVENTION

### Technical Problem

The present invention is contrived to solve the above-mentioned problems. It is an object of the present invention to provide a flow control valve adapted to rapidly supply hot water at a user's desired temperature by promptly controlling the opening rate of a valve depending on the flow of supplied direct water.

### Technical Solution

In order to achieve the above-mentioned object, a flow control valve according to the present invention includes a motor that rotates in both directions; an opening and closing member that reciprocates by rotation of the motor to control the opening rate of a channel; a position varying member of which a position varies integrally with the opening and closing member by the rotation of the motor; and a valve opening rate sensing unit that senses the opening rate of the opening and closing member from an output voltage varying depending on the position of the position varying member.

In this case, the valve opening rate sensing unit may include a linear magnet of which a position varies in accordance with the position of the position varying member; and a magnetic sensor that senses a magnetic flux density varying depending on the position of the linear magnet to control the rotation of the motor.

Herein, the position varying member may include a rotating plate rotating by axial rotation of the motor, of which upper and lower positions vary integrally with the valve, and an upper portion of the linear magnet is in contact with the bottom surface of the rotating plate and a lower portion of the linear magnet is supported by a spring, such that the upper and lower positions of the liner magnet is varied by rotation of the rotating plate.

Meanwhile, the valve opening rate sensing unit may be configured to use a variable resistance.

Further, the valve opening rate sensing unit may be configured to use a variable inductance.

### Advantageous Effects

By a flow control valve of the present invention, it is possible to rapidly supply hot water at a user's desired temperature by promptly controlling the opening rate of an opening and closing member depending on a flow sensed by a flow sensor.

### BRIEF DESCRIPTION OF DRAWINGS

FIG. 1 is a schematic view illustrating a hot water supply system with a known flow control valve;

FIG. 2 is a perspective view of an exterior appearance of a flow control valve according to an embodiment of the present invention;

FIG. 3 is an exploded perspective view of a flow control valve shown in FIG. 2;

FIG. 4 is a cross-sectional view of a flow control valve shown in FIG. 2;

FIG. 5 is a diagram illustrating a shape and an excited shape of a linear magnet adopted in a flow control valve according to the present invention;

FIG. 6 is a cross-sectional view illustrating a state in which a flow control valve is opened according to the present invention;

FIG. 7 is a configuration diagram illustrating the configuration of a hot water supply system with a flow control valve according to the present invention; and

FIG. 8 is a graph illustrating a relationship between a flow and an electric potential difference of a magnetic sensor.

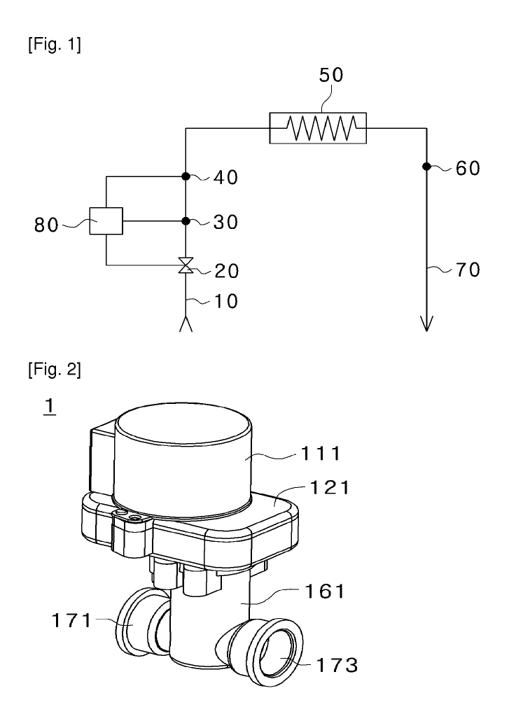

### BEST MODE FOR CARRYING OUT THE INVENTION

Hereinafter, the configuration and operation of a preferred embodiment of the present invention will be described in detail with reference to the accompanying drawings.

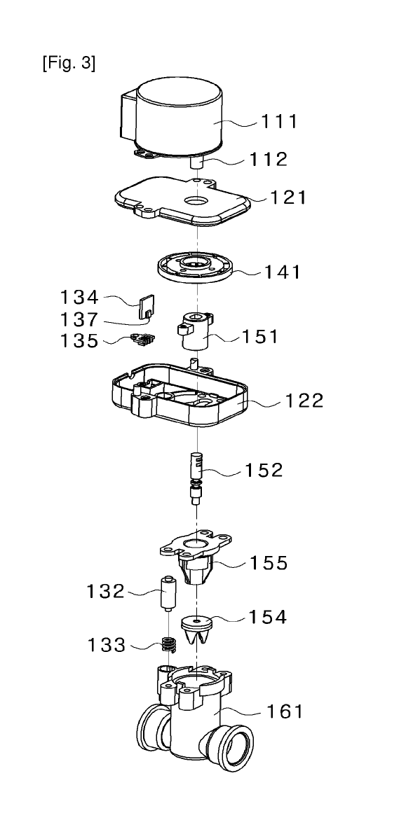

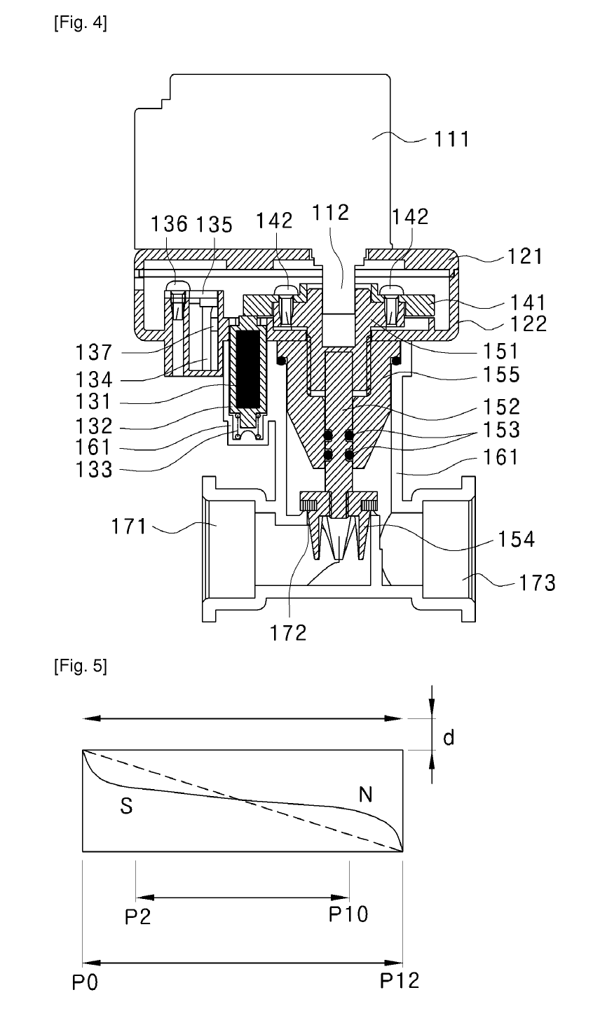

FIG. 2 is a perspective view illustrating an exterior appearance of a flow control valve according to an embodiment of the present invention. FIG. 3 is an exploded perspective view of a flow control valve shown in FIG. 2. FIG. 4 is a cross-sectional view of a flow control valve shown in FIG. 2.

A flow control valve 1 includes a motor 111 that rotates in both directions, an opening and closing member 154 that reciprocates vertically by rotation of the motor 111 to control the opening rate of a channel, a position varying member of which a position is integrally varied with the opening and closing member 154 by the rotation of the motor 111, and a valve opening rate sensing unit that senses the opening rate of the opening and closing member 154 from an output voltage varying in accordance with the position of the position varying member.

The motor 111 rotates by receiving an alternate current (AC) power. Therefore, in comparison with a case of using a motor (e.g., stepping motor) driven by a direct current (DC) power, additional components such as a transformer, a rectifier, etc. need not to be provided, manufacturing cost becomes inexpensive. A motor shaft 112 disposed at a lower portion of the motor 111 has a cross section cut in a ‘D’ shape. The motor shaft 112 is inserted into a groove of a shaft connection member 151, which has a shape corresponding to the ‘D’ shape and rotates altogether with the motor 111.

A long rod shaped shaft 152 that is made of a metallic material is coupled to a lower portion of the shaft connection member 151 to integrally rotate together with the shaft connection member 151. Two O-rings 153 is coupled to a middle portion of the shaft 152 to maintain airtightness with an inner surface of a guide member 155 and the opening and closing member 154 that opens and closes an opening portion 172 which is a channel of direct water is connected to a lower portion of the shaft 152.

The position varying member has a circular disc in which the motor shaft 112 is inserted to a central portion of the position varying member and is composed of a rotating plate 141 installed at an upper portion of the shaft connection member 151. The shaft connection member 151 and the rotating plate 141 are integrally coupled with each other by two screws 142.

The valve opening rate sensing unit includes a linear magnet 131 of which a position is varied by the rotation of the motor 111 and a printed circuit board 134 that is coupled with a magnetic sensor 137 to control the rotation of the motor 111 by sensing magnetic flux density varying depending on the position of the linear magnet 131.

An upper end of a magnet case 132 is installed to be in contact with an outer bottom surface of the rotating plate 141. The magnet case 132 is made of a synthetic resin material and is provided with the linear magnet 131 therein. The bottom surface of the magnet case 132 is elastically supported by a spring 133 and is inserted in the inside of a magnet storing unit 162 formed at one upper end of an outer valve body 161.

The printed circuit board 134 stored in a lower case 122 is installed on the side of the linear magnet 131. A magnetic sensor 137 for sensing the magnetic flux density varying depending on a change of the position of the linear magnet 131 is attached to the printed circuit board 134. A cover 135 is fixedly installed above the printed circuit board 134 by a screw 136 so as to cover the printed circuit board 134.

Herein, the ‘linear magnet’ means a magnet showing linearity in the change of the magnetic flux density depending on the variation. Hereinafter, the linear magnet 131 and the magnetic sensor 137 will be described.

FIG. 5 is a diagram illustrating a shape and an excited shape of a linear magnet adopted in a flow control valve according to the present invention. FIG. 5 is disclosed in Korea Patent Registration No. 660564.

Referring to FIG. 5, in the linear magnet 131, a magnetic wall which is a boundary between an N pole and an S pole has a sine wave shape in a diagonal direction from an upper left edge of a rectangle and the N pole and the S pole are excited.

In general, it is known that the magnetic flux density is in inverse proportion to the square of a length. Accordingly, in the case of a known magnet, a change of the intensity of a magnet depending on the variation does not have linearity as the form of a two-dimensional graph.

Contrary to this, in the case of the linear magnet 131 adopted in the present invention, the magnetic flux density of the N pole depending on the variation does not show the linearity when the magnetic wall is excited in a diagonal direction as the shape of the magnet is indicated by a dotted line as shown in FIG. 5, but when the magnetic wall is excited to have the sine wave shape in the diagonal direction as indicated by a solid line, the magnetic flux density of the N pole depending on the variation shows the linearity.

In FIG. 5, the magnetic sensor 137 senses the change of the magnetic flux density in accordance with the positional change of the linear magnet 131. That is, the magnetic sensor 137 is disposed at a position spaced from a polar surface of the linear magnet 131 by a predetermined gap d and the polar surface of the linear magnet 131 moves on the same surface. Therefore, P0 P12 which is a polar surface section of the linear magnet 131 are spaced from each other at the same interval d while passing through the magnetic sensor 137. At this time, the magnetic flux sensed by the magnetic sensor 137 is linearly. However, since both edges in P0 P12 which is the polar surface section of the magnet show a slight non-linear shape, a section of P2 P10 having an excellent linear property except for both edges of the section P0 P12 is preferably selected as a using section.

The magnetic sensor 137 used for measuring a change of the magnetic flux density depending on the positional change of the linear magnet 131 is composed of a hall sensor (Programmable Hall IC) widely used as one of means for detecting a magnetic field. In the case of the operation of the hall sensor, when a current flows on an electrode of a semiconductor (hall element) and the magnetic field is applied to the electrode in a vertical direction, an electric potential difference is generated in a direction perpendicular to the direction of the current and the direction of the magnetic field. The hall sensor can sense the positional change of the linear magnet 131 from the electric potential difference.

Since the linear magnet 131 and the magnetic sensor 137 are spaced from each other in a non-contact mode, durability of each of the linear magnet 131 and the magnetic sensor 137 is not deteriorated due to repetitive opening and closing of the valve.

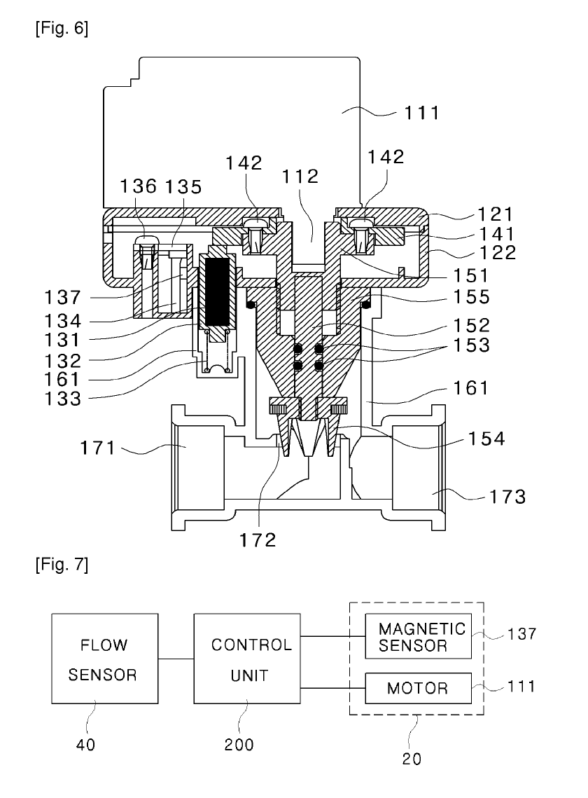

FIG. 6 is a cross-sectional view illustrating a state in which a flow control valve is opened according to the present invention.

FIG. 4 illustrates a state in which a valve is completely closed. In this case, the linear magnet 131 is positioned at a bottom dead point while compressing the spring 133 altogether with the rotating plate 141.

FIG. 6 illustrates a state in which a valve is opened by rotating the motor 111 from the state shown of FIG. 4. In this case, the rotating plate 141 also ascends while rotating altogether with the motor shaft 112, and the shaft 152 and the opening and closing member 154 integrally ascend. Further, the linear magnet 131 also ascends by elastic restoration force of the spring 133 altogether with the rotating plate 141.

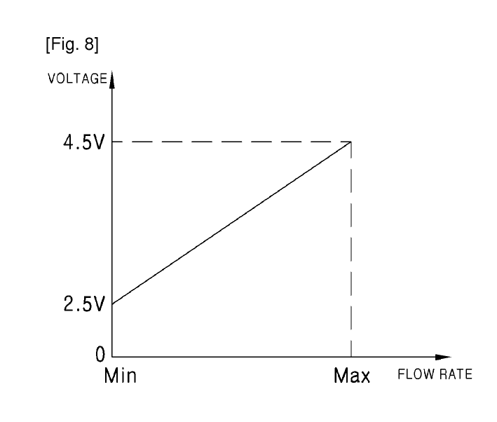

FIG. 7 is a configuration diagram illustrating the configuration of a hot water supply system with the flow control valve according to the present invention. FIG. 8 is a graph illustrating a relationship between a flow and an electric potential difference. Hereinafter, referring to FIGS. 7 and 8, the operation of the present invention will be described.

When a user opens a water faucet to use hot water, the flow sensor 40 senses the flow and ignites a burner (not shown) to supply the heat to the heat exchanger 50.

In this case, the flow sensed by the flow sensor 40 and the temperature of the direct water, which is measured by the direct water temperature sensor 30 are input into the control unit 200, while a target temperature of the hot water is set in advance. From this, in the control unit 200, the amount of heat required for increasing the temperature of the direct water to the target temperature is calculated by the following equation.

Q=mc×Δt

Herein, m represents the flow, c represents specific heat of water and has a value of 1, and Δt represents a difference between the target temperature and the current temperature of the direct water.

In this case, if the capacity (the amount of heat which can be supplied to the maximum) of the boiler is smaller than the required amount of heat calculated in the above-mentioned formula, hot water at a user's desired temperature cannot be supplied even though the burner is operated at the maximum thermal power. Therefore, in this case, the control unit 200 controls the flow control valve 1 by calculating a target flow to decrease the flow of the direct water. A control method of the flow control valve 1 will be described.

In the control unit 200, a relationship between the flow and a voltage sensed by the magnetic sensor 137 depending on the positional change of the linear magnet 131 is set in advance as shown in FIG. 8.

That is, in FIG. 8, when a flow which can pass by opening the flow control valve 1 to the maximum is the maximum flow, a voltage for the position of the linear magnet 131 is set to 4.5 V and when a flow which can pass by completely closing the flow control valve 1 is the minimum flow, a voltage for the position of the linear magnet 131 is set to 0.5 V. Further, when an opening position of the flow control valve 1 is between the maximum flow position and the closing position, a value of a voltage for the position is linearly proportional by the linearity of the linear magnet 131.

Accordingly, in the control unit 200, the target voltage for the target flow is set from the graph data of FIG. 8 and the opening and closing member 154 descends by rotating the motor 111 of the flow control valve 1 to decrease the flow.

When the rotating plate 141 descends while rotating altogether with the motor 111, the linear magnet 131 also descends therewith. When the electric potential difference generated in the magnetic sensor 137 by the positional change of the linear magnet 131 reaches the target voltage, the control unit 200 determines that the flow reaches the target flow to stop the operation of the motor 111.

Of course, even after the flow reaches the target flow, a minute difference may exist between the actual flow and the target flow, a minute adjustment is performed, but when the flow is controlled through such a process, the actual flow may reach the target flow by only one-time operation of the motor 111, which results in rapidly supplying the hot water at the user's desired temperature.

Meanwhile, although it has been described that the valve opening rate sensing unit uses the linear magnet of the non-contact mode in the above description, a variable resistance and a variable inductance may be used instead of the linear magnet and the magnetic sensor.

First, when the variable resistance is used, an output voltage of the variable resistance depending on the opening rate of the valve is set in advance. When a contact position of the variable resistance is varied by the rotation of the motor 111, it is possible to sense the opening rate of the valve from the resultant output voltage.

Further, when the variable inductance is used, an output voltage of the variable inductance depending on the opening rate of the valve is set in advance. When the position of the magnet is varied inside of a coil by the rotation of the motor 111, it is possible to sense the opening rate of the valve from the resultant output voltage.

As described above, although an embodiment of the present invention has been described, the embodiment is just exemplary and it will be appreciated by those skilled in the art that various modifications and changes may be made without departing from the scope and spirits of the present invention.

### INDUSTRIAL APPLICABILITY

As described above, a flow control valve according to the present invention is installed in a boiler or a water heater to rapidly control the flow of direct water supplied to a heat exchanger.

1. A flow control valve, comprising:
a motor that rotates in both directions;
an opening and closing member that reciprocates by rotation of the motor to control the opening rate of a channel;
a position varying member of which a position varies integrally with the opening and closing member by the rotation of the motor; and
a valve opening rate sensing unit that senses the opening rate of the opening and closing member from an output voltage varying depending on the position of the position varying member.

2. The flow control valve according to claim 1, wherein the valve opening rate sensing unit includes:
a linear magnet of which a position varies in accordance with the position of the position varying member; and
a magnetic sensor that senses a magnetic flux density varying depending on the position of the linear magnet to control the rotation of the motor.

3. The flow control valve according to claim 2, wherein the position varying member includes a rotating plate rotating by axial rotation of the motor, of which upper and lower positions vary integrally with the valve, and
an upper portion of the linear magnet is in contact with the bottom surface of the rotating plate and a lower portion of the linear magnet is supported by a spring, such that the upper and lower positions of the liner magnet is varied by rotation of the rotating plate.

4. The flow control valve according to claim 1, wherein the valve opening rate sensing unit uses a variable resistance.

5. The flow control valve according to claim 1, wherein the valve opening rate sensing unit uses a variable inductance.
